(19) United States
(12) Patent Application Publication
(10) Pub. No.: US 2024/0280246 A1
(43) Pub. Date: Aug. 22, 2024

(54) LUMINAIRE ASSEMBLIES FOR TUNNELS AND THE LIKE

(71) Applicant: Schreder S.A., Brussels (BE)

(72) Inventors: Luc DAMHAUT, Liege (BE); Koenraad VAN WINKEL, Liege (BE); Hervé HORTELAN, Liege (BE); Quentin BONDU, Liege (BE)

(21) Appl. No.: 18/570,353

(22) PCT Filed: Jun. 14, 2022
(86) PCT No.: PCT/EP2022/066206

§ 371 Date: Dec. 14, 2023

(30) Foreign Application Priority Data
Jun. 14, 2021 (NL) 2028451

(51) Int. Cl. F21V 15/01; F21V 23/00; F21V 23/06; F21V 31/00; F21W 131/101; F21Y 103/10; F21Y 113/00; F21Y 115/10

(52) U.S. Cl. CPC F21V 15/013; F21V 23/003; F21V 23/06; F21V 31/005; F21W 2131/101; F21Y 2103/10; F21Y 2113/00; F21Y 2115/10

(57) ABSTRACT

An assembly, in particular a luminaire assembly, more in particular for use in tunnels, comprising a trunking profile having an open side, a cover configured to close the open side of the trunking profile, and a light source and/or one or more electrical and/or electronic components arranged in said trunking profile, wherein said cover is provided with a gasket arranged around a periphery of the cover, and wherein the trunking profile is configured to be elastically flexed so as to widen the open side in order to receive the cover and to enclose a portion of the periphery with gasket under tension when deflexed.

### FIELD OF INVENTION

The present invention relates to modular assemblies, in particular modular luminaire assemblies, in particular modular luminaire assemblies for tunnels and the like. The invention also relates to a trunking system comprising a plurality of such luminaire assemblies, and to a method for assembling a luminaire assembly.

### BACKGROUND

Tunnel lighting solutions need to be designed from different perspectives. They need to be designed for tunnel users looking for a safe and comfortable environment, for tunnel maintenance companies looking for an efficient management, for tunnel installation companies looking for optimal installations with a quick, easy installation and commissioning, and finally for tunnel operators looking for a low total cost of ownership.

Tunnel luminaires must for instance meet stringent considerations in terms of mechanical design, light distributions and mountings. In terms of required light distribution, no two tunnels are identical. Each tunnel has its own criteria in terms of lighting, design and geometry, such that modularity of design is highly relevant for luminaire assemblies in that field.

Known modular luminaire assemblies comprise a housing for accommodating a plurality of LEDs and a transparent cover for closing the housing. For example, PCT application PCT/EP2021/054586 in the name of the applicant discloses a thin modular luminaire assembly, particularly suitable for tunnel applications comprising a tray closed by a transparent cover, wherein a seal is inserted between a flange of the tray and the cover and wherein a frame is fixed along a periphery of the cover to fix and press the cover against the seal.

### SUMMARY

The object of embodiments of the invention is to provide an assembly, in particular a luminaire assembly, more particularly suitable for tunnel applications, and a method for assembling a luminaire assembly, which allow for an easier assembly and result in a robust luminaire assembly with good ingress protection.

According to a first aspect of the invention, there is provided an assembly, in particular a luminaire assembly, in particular for use in tunnels, comprising a trunking profile having an open side, a cover configured to close the open side of the trunking profile, and a light source and/or one or more electronic and/or electrical components arranged in said trunking profile. The cover is provided with a gasket arranged around a periphery of the cover. The trunking profile is configured to be elastically flexed so as to widen the open side in order to receive the cover and to enclose a portion of the periphery with gasket under tension when deflexed.

According to a second aspect there is provided a method for assembling an assembly, in particular a luminaire assembly, in particular for use in tunnels, comprising the following steps: providing a trunking profile having an open side; fixing a light source and/or one or more electronic and/or electrical components in said trunking profile via said open side; elastically flexing the trunking profile so as to widen the open side in order to receive a cover; arranging a cover in the open side of the trunking profile, wherein said cover is provided with a gasket arranged around a periphery of the cover; releasing the trunking profile so as to enclose a portion of the periphery with gasket under tension to close the open side.

In that manner the cover can be arranged in a tight manner in the trunking profile resulting in a good ingress protection between trunking profile and cover. Further, assembly is easy and fast without the need for complicated fixation means for fixing the cover and/or gasket. The light source and/or one or more other electronic and/or electrical components may be fixed in the trunking profile before arranging the cover.

Preferably, the trunking profile is configured to receive and enclose a first longitudinal side and an opposite second longitudinal side of the periphery of the cover/gasket assembly. More preferably substantially the entire first and second longitudinal side are received with the exception of the end parts adjacent the lateral sides which may be received in end plates, see further.

The preferred and advantageous features and options discussed below may be combined/implemented both with/in the assembly of the first aspect as well as with/in the method of the second aspect.

Preferably, the cover is transparent or translucent. Especially when the assembly is used for accommodating a light source, at least a portion of the cover is transparent or translucent, and preferably the entire cover is transparent or translucent. The cover may be e.g. a glass plate or a transparent or translucent plastic plate.

Preferably, the gasket has a substantially C-shaped cross section, and the periphery of the cover is received in the gasket with an upper leg of the C-shaped cross section extending over an upper surface of the cover and a lower leg of the C-shaped profile extending over a lower surface of the cover. When the cover is a plate, the gasket may thus extend from a lower surface to an upper surface of the plate. Preferably, the gasket forms a closed loop around the periphery of the cover. Such C-shape has the advantage that the gasket can be snugly and tightly arranged on the cover without a risk of being removed or displaced during mounting.

Preferably, the gasket is made of a rubber-like material, such as a silicone material. Such material can be easily put under tension by the trunking profile and thus provides a good sealing.

Preferably, the trunking profile has a base wall facing the cover and two longitudinal sidewalls connected to opposite longitudinal sides of the base wall so as to form a channel-like longitudinal compartment. Optionally, a longitudinal inner wall extends from the base wall in the direction of the cover, dividing the compartment in two. An end portion of the longitudinal inner wall may be provided with a support wall opposite the cover. Such support wall may serve as a support for fixing the light source and/or one or more electrical and/or electronic components in the trunking profile. To that end the inner wall may be provided with one or more optionally threaded channels for receiving a fixation means for fixing the light source and/or one or more electrical and/or electronic components on the support wall. The channel may be a longitudinal groove in the inner wall extending over the entire length of the trunking profile.

One or more electrical and/or electronic components may be included in the trunking profile. Examples of such electrical and/or electronic components are any one or more of the following: drive circuitry, surge protection circuitry, electrostatic discharge (ESD) protection circuitry, control circuitry, measurement circuitry, communication circuitry, sensor circuitry, antenna circuitry, connectors, a fuse, connection lines, etc.

Preferably, the light source comprises a carrier, such as a PCB, and a plurality of LEDs arranged on the carrier. The carrier may then be fixed on the support wall, e.g. using screws fixed in the channel provided in the inner wall. Optionally, a plurality of optical elements such as lens elements may be arranged over the plurality of LEDs, wherein preferably the plurality of optical elements is integrated in an optical plate. Alternatively or in addition, one or more optical elements can be integrated in the cover.

Optionally, the two longitudinal sidewalls are each provided at an outer surface with a recess or protrusion configured for receiving a bracket for attaching the assembly to a wall, e.g. a wall of a tunnel.

Preferably, the two longitudinal sidewalls are each provided at the inner surface, near the open side, with a substantially U-shaped channel for receiving a longitudinal edge of the periphery of the cover and cooperating in a sealed manner with the gasket provided to the longitudinal edge. Such U-shaped channel further facilitates the correct positioning of the cover in the trunking profile.

Preferably, the assembly further comprises a first and a second end plate, wherein the open side extends longitudinally between a first lateral open end and a second lateral open end of the trunking profile, and wherein the first and second open end are closed with the first and the second end plate, respectively. The first and second end plate may be configured for receiving a first and a second lateral edge of the cover, respectively, and for cooperating in a sealed manner with the gasket provided to the first and second lateral edge, respectively. Preferably, the assembly further comprises a first and second gasket element, preferably a first and second gasket sheet, between the first end plate and a first lateral edge of the trunking profile delimiting the first lateral end and between the second end plate and a second lateral edge of the trunking profile delimiting the second lateral open end, respectively.

The method may further comprise the step of arranging a first and a second end plate to close the first and second open end, respectively, such that the first and second end plate cooperate in a sealed manner with the gasket provided to the cover. Optionally, the method further comprises the step of arranging a first and second gasket element, preferably a first and second gasket sheet, between the first end plate and a first lateral edge of the trunking profile delimiting the first lateral end and between the second end plate and a second lateral edge of the trunking profile delimiting the second lateral open end.

Preferably, the first and/or the second end plate is provided with an mechanical and/or electrical connector interface, such as a socket or cable gland. This will allow interconnecting two or more adjacent assemblies.

Preferably, the trunking profile is an extruded metal profile, preferably an aluminium profile. Preferably, a height of the trunking profile is between 5 cm and 20 cm, preferably between 5 cm and 15 cm. Preferably, a width of the trunking profile, measured as a distance between the outer surfaces of the two sidewalls, is between 10 cm and 20 cm, preferably between 10 cm and 15 cm.

Such height and width dimensions have the advantage that when the trunking profile is an extruded metal profile, a sufficient flexibility can be given to allow for the widening of the open side by flexing the trunking profile. Preferably, a length of the trunking profile is between 50 cm and 200 cm.

Optionally, the trunking profile may be provided with a ridge or other protruding element configured to be gripped by a tool during the assembly of the assembly, in particular the luminaire assembly for widening the open side. However, the skilled person will understand that it is also possible to use a tool which does not require such ridge or protruding element.

Preferably, the light source comprises a plurality of LED arrays each comprising at least four LEDs. The LED arrays may be arranged on separate carriers, e.g. printed circuit boards. Optionally, a plurality of optical elements such as lens elements is arranged over the plurality of LED arrays, wherein preferably the plurality of optical elements is integrated in one or more optical plates, preferably lens plates.

Preferably, the optical elements comprise a plurality of lens elements associated with the plurality of LEDs. Optionally, the plurality of lens elements may be integrated in one or more optical lens plates arranged above the one or more carriers on which the LEDs are mounted. Indeed, lens elements may be typically encountered in luminaire assemblies, although other types of optical elements may be additionally or alternatively present in such luminaires assemblies, such as reflectors, backlights, prisms, collimators, diffusors, and the like. In the context of the invention, a lens element may include any transmissive optical element that focuses or disperses light by means of refraction. It may also include any one of the following: a reflective portion, a backlight portion, a prismatic portion, a collimator portion, a diffusor portion. For example, a lens element may have a lens portion with a concave or convex surface facing a light source, or more generally a lens portion with a flat or curved surface facing the light source, and optionally a collimator portion integrally formed with said lens portion, said collimator portion being configured for collimating light transmitted through said lens portion. Also, a lens element may be provided with a reflective portion or surface or with a diffusive portion or surface.

Alternatively or additionally, optical elements or features may be integrated in the cover (e.g. variation of thickness, transparency, diffusivity, reflectivity, refractivity, color temperature, etc.).

Additionally, the optical elements may further comprise one or more light shielding structures complying with different glare classifications, e.g. the G classification defined according to the CIE115:2010 standard and the G* classification defined according to the EN13201-2 standard. The light shielding structures may be configured for reducing a solid angle of light beams of the plurality of first and/or second light sources by cutting off or reflecting light rays having a large incident angle, thereby reducing the light intensities at large angles and improving the G/G* classification of the luminaire system. The one or more optical elements may comprise on the one hand a lens plate comprising a plurality of lenses covering the plurality of LEDs, and on the other hand one or more light shielding structures mounted on said lens plate. Exemplary embodiments of shielding structures are disclosed in Dutch patent application N2023295 in the name of the applicant and PCT/EP2019/074894 in the name of the applicant, which are included herein by reference. Further examples of louver elements are disclosed in PCT patent application PCT/EP2020/066221 and Dutch application N2025168 in the name of the applicant, which are included herein by reference. Further, a spacer layer may be disposed between the carrier and the one or more optical elements. The spacer layer is provided with one or more holes through which one or more light emitting elements of the light source extend. Examples of spacer layers are disclosed in Dutch patent application N2025166 in the name of the applicant, which is included herein by reference.

In a possible embodiment the optical elements may be arranged in a movable manner with respect to the carrier, and thus with respect to the LEDs. For example, a LED may be arranged under a so-called double bulged lens. This is a lens element having an internal surface and/or an external surface comprising a first curved surface and a second curved surface, said first curved surface being connected to said second curved surface through a connecting surface or line comprising a saddle point or discontinuity. When the external surface is implemented as described, preferably the external surface comprises a first outwardly bulging surface, a second outwardly bulging surface, and an external connecting surface or line connecting said first and second outwardly bulging surfaces. However, it is also possible to have a continuous outer surface and to implement only the internal surface as described. When the internal surface is implemented as described. preferably the internal surface comprises a first outwardly bulging surface, a second outwardly bulging surface, and an internal connecting surface or line connecting said first and second outwardly bulging surfaces. The term “outwardly bulging surface” is used here to refer to a surface which bulges outwardly, away from the associated LED. An outwardly bulging external surface forms a protruding portion, whilst an outwardly bulging internal surface forms a cavity facing the associated light source. By providing such curved surfaces, the optical elements are given a “double bulged” shape allowing to generate a distinct intensity distribution for the first beam associated with a first bulge of a double bulged surface and the second beam associated with a second bulge of a double bulged surface. Examples of such double bulged surfaces are disclosed in PCT publication WO2019134875A1 in the name of the applicant which is included herein by reference. According to another example, a moving reflector may be used e.g. to cut light at large angles more or less based on distance between the luminaire assemblies.

In a possible configuration, all LED arrays are connected in series. In another embodiment, a first branch of LED arrays is electrically connected in series and a second branch of LED arrays is electrically connected in series, wherein the first branch is electrically connected in parallel to the second branch. In this manner a double balanced circuit may be obtained. Preferably a LED array of the first branch is arranged between two LED arrays of the second branch. This may further improve the light distribution.

According to yet another aspect there is provided a trunking system comprising a plurality of assemblies, in particular luminaire assemblies according to any one of the previous embodiments. The plurality of assemblies may be mechanically and/or electrically interconnected. The trunking system may further comprise at least one driver with driver circuitry for driving the plurality of assemblies, in particular luminaire assemblies. Such driver may be arranged in a separate housing which is different from the trunking profile of the assemblies. In other embodiments, the driver may be arranged in a trunking profile of an assembly in addition to or instead of a light source. Optionally, an assembly of the plurality of assemblies comprises in its trunking profile any one or more of the following: an optical module (e.g. a light emitting or receiving means), a sensor module, a signalling module, a communication module (e.g. receiving/emitting unit), a disinfection unit (e.g. a UV disinfection unit). Such component may be included instead of the light source or in addition to the light source.

Preferred embodiments relate to outdoor luminaire assemblies and/or industrial lighting assemblies. By outdoor and/or industrial luminaire, it is meant luminaires which are installed on roads, tunnels, industrial plants, stadiums, airports, harbours, rail stations, campuses, parks, cycle paths, pedestrian paths or in pedestrian zones, for example, and which can be used notably for the lighting of an outdoor and/or industrial area, such as roads and residential areas in the public domain, private parking areas, access roads to private building infrastructures, warehouses, industry halls, etc. Particular preferred embodiments relate to luminaire assemblies for tunnels, or bridges where the luminaire is supported, in particular suspended with respect to a ceiling or an overhang.

In embodiments of the invention, the amount of LED arrays to be included in the luminaire assembly may be chosen in function of the lighting needs. In this way, the light distribution can be adapted, creating more flexibility for the use of the luminaire assembly. Indeed by using a different amount of LED arrays, various combinations for the positioning of the LED arrays can be envisaged.

The features of the different aspects and embodiments described above may be combined in any possible way.

### BRIEF DESCRIPTION OF THE FIGURES

This and other aspects of the present invention will now be described in more detail, with reference to the appended drawings showing currently preferred embodiments of the invention. Like numbers refer to like features throughout the drawings.

FIG. 1 is a schematic exploded perspective view of a luminaire assembly according to an exemplary embodiment.

FIG. 2 is a schematic perspective view of the luminaire assembly of FIG. 1.

FIG. 3 is a perspective view of a gasket and gasket sheet suitable for use in the embodiment of FIGS. 1 and 2.

FIG. 4 is a cross-sectional exploded view of the embodiment shown in FIG. 1.

FIG. 5 is a cross-sectional exploded view illustrating the flexing of a trunking profile.

FIG. 6 is a schematic view of two LED arrangements which may be used in exemplary embodiments.

### DESCRIPTION OF THE EMBODIMENTS

Preferred embodiments relate to outdoor luminaire assemblies. By outdoor luminaire, it is meant luminaires which are installed on roads, tunnels, industrial plants, campuses, parks, stadiums, airports, harbours, rail stations, cycle paths, pedestrian paths or in pedestrian zones, for example, and which can be used notably for the lighting of an outdoor area, such as roads and residential areas in the public domain, private parking areas, access roads to private building infrastructures, etc. Particular preferred embodiments relate to luminaire assemblies for tunnels, or bridges where the luminaire is supported by a wall, and in particular suspended from a ceiling.

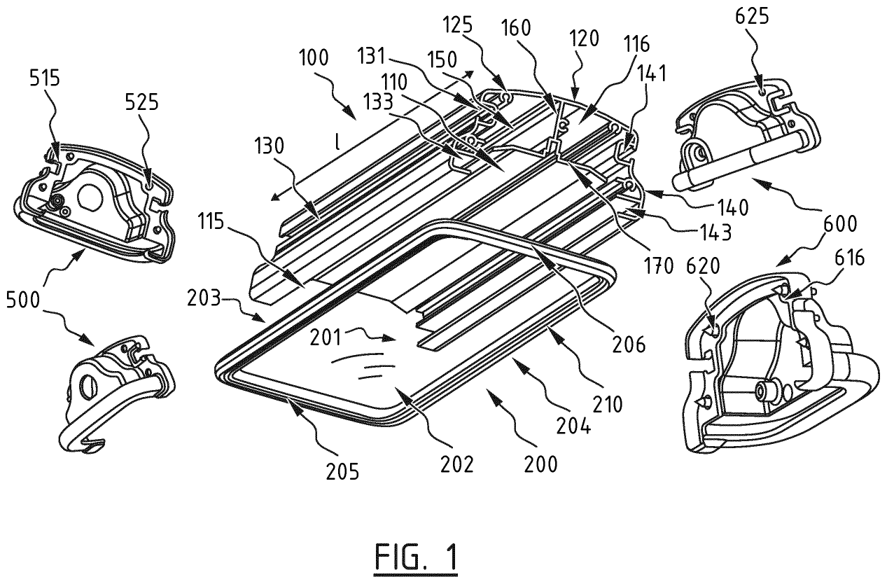

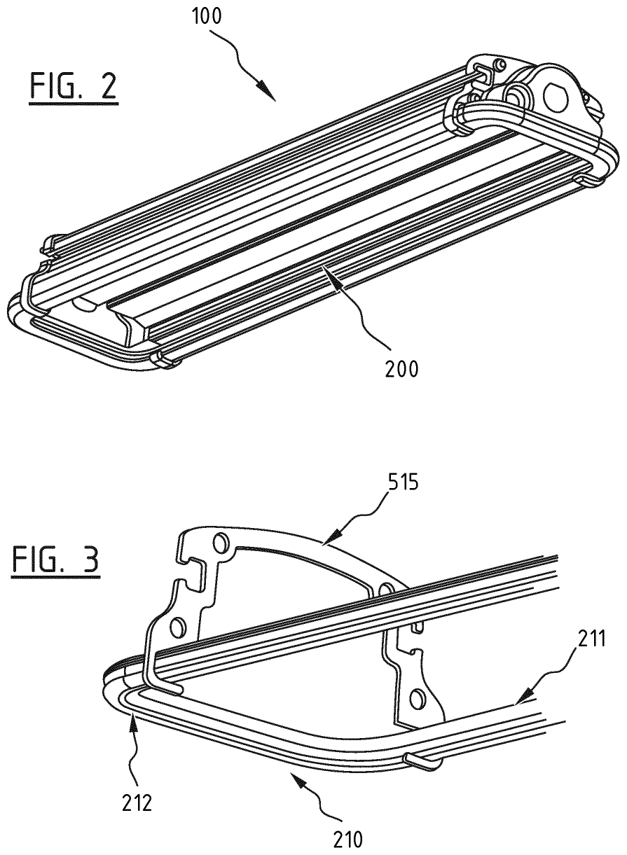

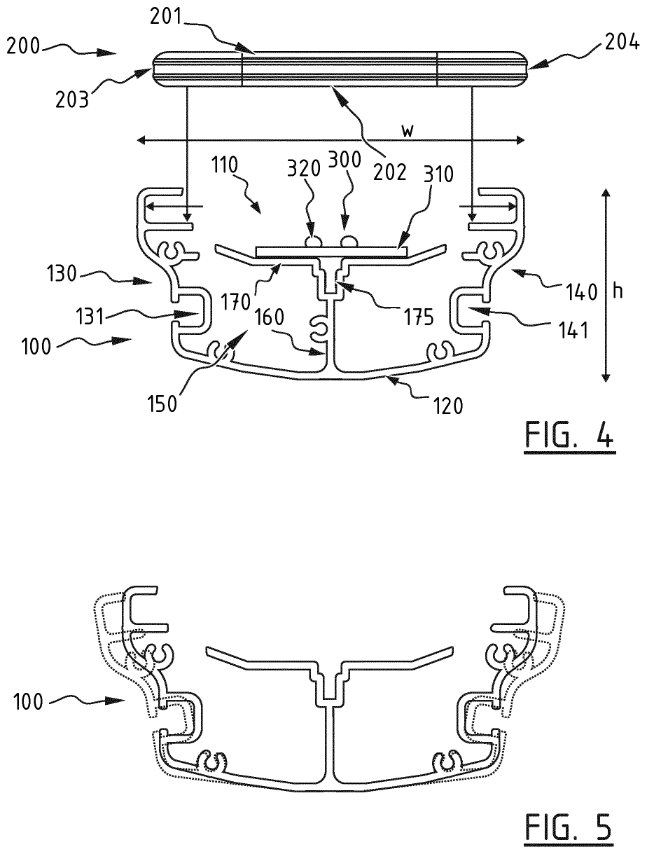

FIGS. 1 and 2 show a luminaire assembly in particular for use in tunnels, comprising a trunking profile 100 and a cover 200. The assembly is intended to accommodate a light source and/or one or more electrical and/or electronic components in trunking profile 100, see also FIG. 4 where a light source 300 is illustrated.

The trunking profile 100 has an open side 110 and the cover 200 is configured to close the open side 110. The trunking profile 100 has a base wall 120 facing the cover 200 and two longitudinal sidewalls 130, 140 connected to either side of the base wall so as to form a channel-like longitudinal compartment 150. The trunking profile 100 further comprises a longitudinal inner wall 160 extending from the base wall 120 in the direction of the cover 200, dividing the compartment 150 in two. An end portion of the longitudinal inner wall 150 may be provided with a support wall 170 opposite the cover 200, see also FIG. 4. The light source 300 may comprise a carrier 310, e.g. a printed circuit board, with a plurality of LEDs 320, and the carrier 310 may be arranged on the support wall 170, see FIG. 4. Optionally, a plurality of optical elements (not shown) such as lens elements may be arranged over the plurality of LEDs 320, wherein the plurality of optical elements may be integrated in an optical plate, e.g. a lens plate as known in the art. Preferably, a plurality of LED arrays each comprising at least four LEDs 320, is arranged in the trunking profile 100. The carrier 310 may be fixed with one or more screws or bolts (not shown) extending through the carrier 310 into a threaded channel 175 provided below the support wall 170 and integrated with the internal wall 160.

Preferably, the trunking profile 100 is an extruded metal profile, preferably an aluminium profile. Preferably, a height h (see FIG. 4) of the trunking profile 100 is between 5 cm and 20 cm, more preferably between 5 cm and 15 cm. Preferably, a width w (see FIG. 4) of the trunking profile 100, measured as a distance between the outer surfaces of the two sidewalls 130, 140, is between 10 cm and 20 cm, more preferably between 10 cm and 15 cm. Such height and width dimensions have the advantage that when the trunking profile is an extruded metal profile, a sufficient flexibility can be given to allow for the widening of the open side 110 by flexing the trunking profile 100, as will be explained in more detail below. Preferably, a length l (see FIG. 1) of the trunking profile 100 is between 50 cm and 200 cm.

The cover 200 is provided with a gasket 210 arranged around a periphery of the cover 200. Preferably, the cover 200 is transparent or translucent. Especially when the assembly accommodates a light source the cover 200 will be at least partially transparent or translucent. Preferably, the cover 200 is a plate, e.g. a glass or plastic plate.

The trunking profile 100 is configured to be elastically flexed so as to widen the open side 110 in order to receive the cover 200 and to enclose a portion of the periphery with gasket 210 under tension when deflexed. The flexing of the trunking profile 100 is illustrated in FIG. 5. This flexing may be performed using a tool, such as a jig. In that manner the cover can be easily arranged in the trunking profile without the need for screws whilst ensuring a good tightness. It is noted that the light source 300, e.g. a plurality of LEDs 320 on a carrier 310 (see FIG. 4) and/or one or more electrical or electronic components, may be arranged in the trunking profile and tested electrically before the cover 200 is arranged.

The gasket 210 is shown in FIG. 1 and in more detail in FIG. 3. The gasket 210 has a substantially C-shaped cross section, and the periphery of the cover 200 is received in the gasket with an upper leg 211 of the C-shaped cross section extending over an upper surface 201 of the cover 200 and a lower leg 212 of the C-shaped profile extending over a lower surface 202 of the cover 200. Such shape has the advantage that the gasket 210 is snugly arranged on the cover 200 without a risk of being removed or displaced during mounting. The two longitudinal sidewalls 130, 140 may each be provided at the inner surface, near the open side, with a substantially U-shaped channel 133, 143 for receiving a longitudinal edge of the periphery of the cover 200 and cooperating in a sealed manner with the gasket 210 provided to the longitudinal edge. Preferably, the gasket is made of a rubber-like material such as a silicone material.

The two longitudinal sidewalls 130, 140 of the trunking profile 100 may each be provided at an outer surface with a recess 131, 141 configured for receiving a bracket (not shown) for attaching the assembly to a wall, e.g. a wall of a tunnel. In that manner, the luminaire assembly can be easily installed without the need for complex mounting mechanisms.

As shown in FIGS. 1 and 2, the luminaire assembly further comprises a first and a second end plate 500, 600. The open side 110 of the trunking profile 100 extends longitudinally between a first lateral open end 115 and a second lateral open end 116 of the trunking profile. The first and second open end 115, 116 are closed with the first and the second end plate 500, 600, respectively. The first and second end plate 500, 600 are configured for receiving a first and a second lateral edge 205, 206 of the cover 200, respectively, and for cooperating in a sealed manner with the gasket 210 provided to the first and second lateral edge 205, 206, respectively. The luminaire assembly may further comprise a first and second gasket element 515, 516 between the first end plate 500 and a first lateral edge of the trunking profile 100 delimiting the first lateral end 115 and between the second end plate 600 and a second lateral edge of the trunking profile 100 delimiting the second lateral open end 116, see FIG. 1 and FIG. 3. In that manner, also the lateral ends 115, 116 are tightly sealed. As shown in FIGS. 1 and 3, the first and second gasket elements 515, 616 (616 is not drawn but the position is indicated and it will be understood that 616 is similar to 515) may be sheet-like and shaped to be fitted in the corresponding end plate 500, 600 further facilitating the assembly of the luminaire assembly. Indeed, the gasket sheets 515, 616 may be arranged in advance in the end plates 500, 600, whereupon the end plates 500, 600 may be fixed to the trunking profile 100 using e.g. screws 620, clamps or other fixation means. To that end the end plates 500, 600, may be provided with holes 525, 625 and the trunking profile may be provided with channels 125 to receive the screws. The first and/or the second end plate 500, 600 may be provided with a mechanical and/or electrical connector interface, e.g. a connector socket or a cable gland.

In a preferred configuration of a trunking system, a plurality of luminaire assemblies according to any one of the above described embodiments is arranged along a line or other predetermined pattern, e.g. in a tunnel. The plurality of luminaire assemblies may be mechanically and/or electrically interconnected, e.g. through connector interfaces in the end plates 500, 600. The trunking system may further comprise at least one driver with driver circuitry for driving the plurality of luminaire assemblies (not illustrated), and in particular for driving the plurality of LED arrays of the luminaire assemblies.

Although the illustrated assembly is especially suitable for housing a light source, it is also possible that an assembly accommodates in its trunking profile any one or more of the following: an optical module, a sensor module, a signalling module, a communication module (e.g. receiving/emitting unit), a disinfection unit (e.g. a UV disinfection unit).

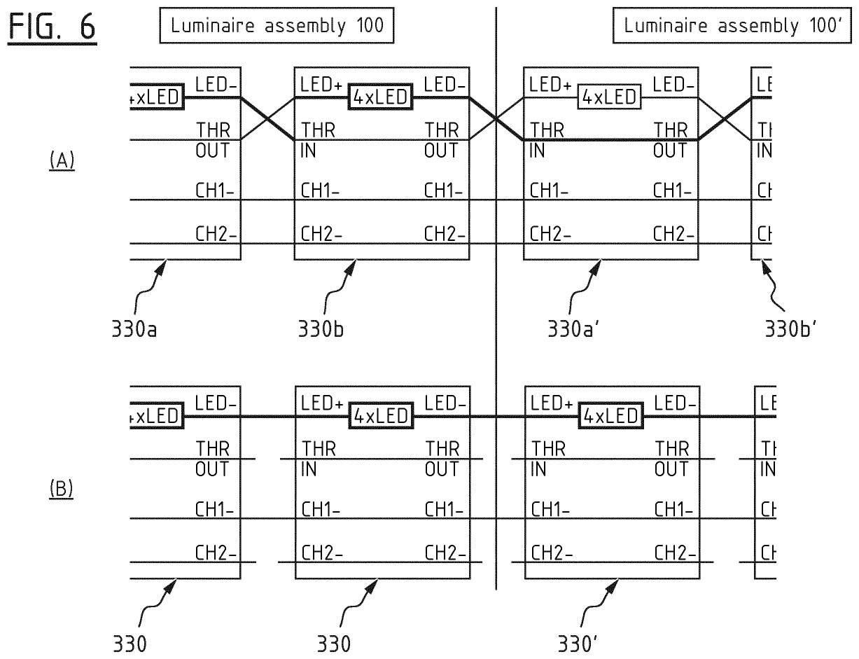

FIG. 6 illustrates two possible LED arrangements (A) and (B) in adjacent luminaire assemblies 100, 100′.

In set-up (B) of FIG. 6, luminaire assembly 100 comprises a first set of LED arrays 330 connected in series, luminaire assembly 100′ comprises a second set of LED arrays 330′ connected in series, and the first set is connected in series with the second set through a connector interface between the adjacent luminaire assemblies 100, 100′.

In set-up (A) of FIG. 6, luminaire assembly 100 comprises a first group of LED arrays 330a connected in series and a second group of LED arrays 330b connected in series. Similarly, luminaire assembly 100′ comprises a first group of LED arrays 330a′ connected in series and a second group of LED arrays 330b′ connected in series. The first group of LED arrays 330a is connected in series with the first group of LED arrays 330a′. Similarly, the second group of LED arrays 330b is connected in series with the second group of LED arrays 330b′. The LED arrays may be arranged such that a LED array of the first group 330a, 330a′ is located between two LED arrays 330b, 330b′ of the second group. In that manner two evenly distributed parallel branches are obtained: a first branch with LED arrays 330a, 330a′ and a second branch with LED arrays 330b, 330b′.

A skilled person would understand that the modularity of the arrangement may be further adapted to the needs of the lighting situation. In particular different sort of assemblies, differing in the number of LED arrays may be used in different parts of the tunnel based on the luminance and the light distribution required in said parts of the tunnel. For instance assemblies with more LED arrays may be used in zones of the tunnel where a high luminance is required, like the entrance and exit zones. Assemblies with less LED arrays may be used in a tunnel zone with an intermediate luminance, like a transition zone, or in tunnel zones with a basic illuminance, like the central interior zone of the tunnel. The whole tunnel may then be illuminated by a combination of many assemblies in order to cover the whole length of the tunnel. Also the required light distribution may be different in different parts of a tunnel. For example, some parts may require only a lighting of the road whilst other parts may require lighting of the walls. By suitably choosing the number, orientation and type of luminaire assemblies, this can be easily achieved.

Whilst the principles of the invention have been set out above in connection with specific embodiments, it is understood that this description is merely made by way of example and not as a limitation of the scope of protection which is determined by the appended claims.

1. An assembly, in particular a luminaire assembly, more in particular for use in tunnels, comprising a trunking profile having an open side, a cover configured to close the open side of the trunking profile, and a light source and/or one or more electrical and/or electronic components arranged in said trunking profile, wherein said cover is provided with a gasket arranged around a periphery of the cover, and wherein the trunking profile is configured to be elastically flexed so as to widen the open side in order to receive the cover and to enclose a portion of the periphery with gasket under tension when deflexed.

2. The assembly of claim 1, wherein the cover is transparent or translucent.

3. The assembly of claim 1, wherein the gasket has a substantially C-shaped cross section, and wherein the periphery of the cover is received in the gasket with an upper leg of the C-shaped cross section extending over an upper surface of the cover and a lower leg of the C-shaped profile extending over a lower surface of the cover.

4. The assembly of claim 1, wherein the cover is a plate and the gasket extends from a lower surface to an upper surface of the plate.

5. The assembly of claim 1, wherein the trunking profile has a base wall facing the cover and two longitudinal sidewalls connected to opposite longitudinal sides of the base wall so as to form a channel-like longitudinal compartment.

6. The assembly of claim 5, wherein a longitudinal inner wall extends from the base wall in the direction of the cover, dividing the compartment in two.

7. The assembly of claim 6, wherein an end portion of the longitudinal inner wall is provided with a support wall opposite the cover.

8. The assembly of claim 7, wherein the inner wall is provided with a threaded channel for receiving a fixation means for fixing the light source and/or one or more electrical and/or electronic components on the support wall, and/or
wherein the light source comprises a carrier with a plurality of LEDs, and wherein the carrier is fixed on the support wall.

9. (canceled)

10. The assembly of claim 5, wherein the two longitudinal sidewalls are each provided at an outer surface with a recess or a protrusion configured for receiving a bracket for attaching the assembly to a wall, e.g. a wall of a tunnel, and/or
wherein the two longitudinal sidewalls are each provided at the inner surface, near the open side, with a substantially U-shaped channel for receiving a longitudinal edge of the periphery of the cover and cooperating in a sealed manner with the gasket provided to the longitudinal edge.

11. (canceled)

12. The assembly of claim 1, further comprising a first and a second end plate, wherein the open side extends longitudinally between a first lateral open end and a second lateral open end of the trunking profile, and wherein the first and second open end are closed with the first and the second end plate, respectively.

13. The assembly of claim 12, wherein the first and second end plate are configured for receiving a first and a second lateral edge of the cover, respectively, and for cooperating in a sealed manner with the gasket provided to the first and second lateral edge, respectively, and/or
wherein the assembly further comprises a first and second gasket element, preferably a first and second gasket sheet, between the first end plate and a first lateral edge of the trunking profile delimiting the first lateral end and between the second end plate and a second lateral edge of the trunking profile delimiting the second lateral open end, respectively.

14. (canceled)

15. The assembly of claim 1, wherein the first and/or the second end plate is provided with a mechanical and/or electrical connector interface, such as a socket or cable gland, and/or
wherein a height of the trunking profile is between 5 cm and 20 cm, preferably between 5 cm and 15 cm, and/or
wherein a width of the trunking profile, measured as a distance between the outer surfaces of the two sidewalls, is between 10 cm and 20 cm, preferably between 10 cm and 15 cm, and/or
wherein a length of the trunking profile is between 50 cm and 200 cm.

16. (canceled)

17. (canceled)

18. (canceled)

19. The assembly of claim 1, wherein the light source comprises a plurality of LED arrays each comprising at least four LEDs.

20. The assembly of claim 19, wherein a plurality of optical elements such as lens elements is arranged over the plurality of LED arrays, and wherein preferably the plurality of optical elements is integrated in one or more optical plates, preferably lens plates, and/or
wherein the plurality of LED arrays comprises a first branch of LED arrays electrically connected in series and a second branch of LED arrays electrically connected in series, wherein the first branch is electrically connected parallel to the second branch, and wherein preferably a LED array of the first branch is arranged between two LED arrays of the second branch.

21. (canceled)

22. The assembly of claim 1, wherein the trunking profile is an extruded metal profile, preferably an aluminium profile.

23. The assembly of claim 1, wherein the trunking profile is provided with a ridge or other element configured to be gripped by a tool during the assembly of the luminaire assembly for widening the open side.

24. A trunking system comprising a plurality of assemblies according to claim 1.

25. The trunking system of claim 24, wherein the plurality of assemblies are mechanically and/or electrically interconnected, and/or
wherein the trunking system further comprises at least one driver with driver circuitry for driving the plurality of assemblies, and/or
wherein an assembly of the plurality of assemblies comprises in its trunking profile any one or more of the following: an optical module (e.g. a light emitting or receiving means), a sensor module, a signalling module, a communication module (e.g. receiving/emitting unit), a disinfection unit (e.g. a UV disinfection unit).

26. (canceled)

27. (canceled)

28. A method for assembling an assembly, in particular a luminaire assembly, more in particular for use in tunnels, comprising the steps of:
providing a trunking profile having an open side;
fixing a light source and/or an electronic component in said trunking profile via said open side;
elastically flexing the trunking profile so as to widen the open side in order to receive a cover;
arranging a cover in the open side of the trunking profile, wherein said cover is provided with a gasket arranged around a periphery of the cover; and
releasing the trunking profile so as to enclose a portion of the periphery with gasket under tension to close the open side.

29. The method of claim 28, wherein the open side extends longitudinally between a first lateral open end and a second lateral open end of the trunking profile, and wherein the method further comprises the step of arranging a first and a second end plate to close the first and second open end, respectively, such that the first and second end plate cooperate in a sealed manner with the gasket provided to the cover, and/or
wherein the method further comprises the step of arranging a first and second gasket element, preferably a first and second gasket sheet, between the first end plate and a first lateral edge of the trunking profile delimiting the first lateral end and between the second end plate and a second lateral edge of the trunking profile delimiting the second lateral open end.

30. (canceled)
